(19) United States
(12) Patent Application Publication
(10) Pub. No.: US 2006/0139378 A1
(43) Pub. Date: Jun. 29, 2006

(54) Driving method for high frame rate display system

(76) Inventors: Kwok-wai Hon, Tseung Kwan O (HK); Wing-sum Mak, Tseung Kwan O (HK)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/266,840

(22) Filed: Nov. 4, 2005

(30) Foreign Application Priority Data
Nov. 5, 2004 (GB) 0424543.7

(51) Int. Cl. G09G 5/10

(52) U.S. Cl. 345/692

(57) ABSTRACT

The invention relates to a device and driving method for increasing frame rate of a display system without increasing its video input data rate. Or, reducing its input data rate at reasonable display frame rate without flickering. The device uses a driving scheme which consists of bit set generation, bit set controlling and display device partitioning. The driving scheme may divide a conventional binary PWM pulse into a binary Secondary Bit Set (SBS) and a segmented Primary Bit Set (PBS). It may also create bit sets with pre-defined display time and display sequences for partitioned display device. The driving scheme enables the use of lower frequency video circuitry to provide high frame rate display image at standard television resolutions with improved image gradation.

### FIELD OF THE INVENTION

The present invention relates to display devices and more particularly to a method for driving a pixilated display devices, such as LCD, LCOS, OLED, etc.

### BACKGROUND OF THE INVENTION

This is evident in the recent growth of low cost, high resolution display products in the consumer market. The demand is driven by the need for replacement of cathode-ray tube (CRT) displays which use an electron gun. A CRT projection display possesses the disadvantages of low luminous output, poor definition of text for data application, bulky, with a large footprint, heavy weight, and high power consumption. A new generation of liquid crystal (LC) display has the advantages of being portable and having a low-power operation, which fulfills the demand of handheld devices, such as mobile phones and personal digital organisers. Another new technology based on Active Matrix Liquid Crystal Display (AMLCD), such as Liquid Crystal on Silicon (LCOS), has a further advantage in its high resolution, to accomplish the desires of high resolution Rear Projection Television (RPTV) and multimedia front projector.

A Liquid Crystal Display (LCD) basically consists of two electrodes formed by coating a transparent ITO (indium tin oxide) layer on the glass substrates. In between these electrodes a thin layer of liquid crystal (LC) is captured. The inner surface of the electrodes is coated with a buffed polymer for aligning the molecules of the LC. LC molecules require a DC-balanced voltage for operation with the purpose of preventing it form electrochemical reactions. When an appropriate AC driving voltage is applied to the electrodes, an electric field is induced across the electrodes, which may be plates and LC molecules captured inside are subjected to this induced electric field. Influenced LC molecules rotate and align themselves in the direction of the applied electric field. This alignment change determines the optical properties and the polarization of the light passing through it. By polarizing the incident light using electrical pulses with little power, brightness and contrast of the LCD is controlled. The stage of light polarization manipulation of LC is responsive to a root-mean-square (RMS) voltage. Contrast of the display then depends on the applied RMS voltage level across the LC layer. This measure of displaying images by light manipulation makes LCDs the preferred technology for handheld display devices.

A passive LCD is simple and economical to make which makes it dominant in the market of handheld devices. However, its display size is limited because the more rows in the display, the shorter is the time of the applied voltage. Together with crosstalk effect between neighboring pixel voltages, large passive-matrix LCD always suffer from low contrast, limited viewing angle, and limited grayscale.

One solution for high a resolution LCD is the use of Active Matrix Liquid Crystal Display (AMLCD). In AMLCD, a switch is placed at each pixel of a pixilated display device. This switch, such as a transistor or a diode, lets the pixel act as a storage element and hence makes the pixel matrix become active. TFT LCD is one of the benchmarks of AMLCD technology. It is a mature display technology and is a miniature high-resolution version of what is available for direct-view LCD applications. Nevertheless, each TFT element occupies a certain area (usually 40%) of the pixel. Thus the light throughput is significantly reduced and heat is generated. This factor generates difficulty in achieving smaller pixel for higher resolution.

A new generation of display technology, based on Liquid Crystal On Silicon (LCOS), offers a high throughput, high pixel aperture ratio, and high luminance solution for AMLCD display device. Reflective LCOS technology creates a way to achieve ultra high-resolution for the newer commercial television broadcasting standards, such as HDTV. A LCOS display consists of a silicon substrate and a common transparent ITO electrode coated on the glass substrate. As for an LCD, in between the electrodes is a thin layer of LC. Circuitries on the silicon substrate provide voltage on an electrode at each pixel so as to produce an electric field for controlling the LC optical properties. These pixel electrodes act as reflecting mirrors as well. Light incident on the device through the transparent electrode is modulated by the LC electro-optics in response to the voltage applied to each pixel. The reflected image is directed by projection optics to a screen or directed by optical lens for direct-view application.

One of the conventional architectures for AMLCD is a DRAM-like pixel array circuitry. Its storage element consists only a switch and a storage component. For instance, an analog storage element is composed of a transistor having a gate connected to a gate line, a source connected to a data line, and a drain connected to a storage capacitor. A standard addressing mode of this architecture is to select one gate line (row) at a time from top to bottom of the array while the data drivers connected to corresponding data lines (column) provide the driving voltages to be written to the pixels. When a transistor is turned on by activating its gate line, voltage on its data line is written to its storage capacitor. When a storage capacitor is directly connected to a pixel mirror, a LC voltage is established between the mirror electrode and the common transparent ITO across the LC layer. Using a typical twisted nematic LC mode in this device may require a RMS voltage ranging from 1 Vrms to 4 Vrms, i.e. approximately 8V peak to peak operating voltage swing. In this situation, the structure of pixel cell must be precisely constructed by using fabrication processes other than standard CMOS logic so as to store and sustain the accurate LC voltage levels for displaying its corresponding grayscale level. As a result, designing precise pixel cells and digital-to-analog circuitries becomes an obstacle of constructing an analog storage structure AMLCD.

Apart form applying a high voltage level to a pixel mirror, grayscale levels can be rendered digitally by using pulse-width-modulation (PWM). For AMLCD using digital PWM driving, a digital storage element replaces the analog switch and the storage capacitor. In the case of using digital storage element, digitized voltage pulse is applied on the pixel mirror. A thin LC layer between the mirror electrode and the common ITO glass electrode transforms the applied digital voltage pulse into analog RMS voltage under a digital-to-analog mechanism performed by the LC molecules lying between the LC layer. By taking all pulses applied on a pixel mirror as a whole within a frame time, a variety of grayscale levels are achieved. In particular, binary weighted PWM is frequently used for the reason that increase of bits of binary weighted PWM directly improves the resolution of grayscale to be displayed. For simplicity, the PWM scheme is illustrated for a word containing 4-bit. A 4-bit word in PWM scheme segregates a frame time into 16 time intervals (grouped in 1, 2, 4, and 8). Each bit in the word, 2⁰, 2¹, 2², and 2³, has its own time duration for applying voltage pulse on the mirror electrode. In binary weight PWM, bit (2⁰) has the shortest time interval (1) commonly entitled as the least significant bit (LSB). Bit (2¹) has two time intervals (2) and bit (2²) has four time intervals (4). Remaining bit (2³) is known as the most significant bit (MSB) containing the longest time interval (8). By varying the combinations of bits in the 4-bit word, different grayscale level is achieved. The possible grayscale levels produced in the 4-bit word are 16 and an 8-bit word produces 256 possible grayscale levels.

A basic AMLCD, whether using an analog storage scheme or a PWM scheme, comprises row drivers generating voltage pulses for gate-line operations and column drivers generating voltages for pixel data. For instance, a VGA display device contains 640 column (data) drivers and 480 row (gate) drivers. In addressing the AMLCD, the row drivers apply voltage pulses to storage elements to enable data writing operations. Data writing operations run sequentially, one row at a time from top to bottom of the display device. This row selection process starts and repeats until all of the 480 rows are selected consecutively. For any images displayed in a LCD, it must be continuously refreshed. That is, data of an image must be rewritten to the pixel mirror so as to preserve the “DC-balancing” of LC molecules. Time needed for addressing all these 480 rows for a single image then becomes an important factor for determining the refresh rate of the display.

It is well established that another factor for determining a refresh rate is flicker considerations. A flicker-free display operation requires the use of high frame rate. Video Electronics Standards Association (VESA) drives the flicker-free refresh rate to 75 Hz or 80 Hz and today's well-accepted refresh rate for a flicker-free display is 70 Hz and above. Accordingly, data addressing circuitries are pushed to their frequency limits because the higher refresh rate, the higher is the data addressing speed. For a VGA display device running a 70 Hz refresh rate and having 4 bits per primary color for a PWM scheme, the refresh bandwidth is (640×480×16×70) Hz. With improvement of grayscale levels, display with data word containing 8 bits radically increases the refresh bandwidth to (640×480×256×70) Hz. Alone with the grayscale levels, resolution of the display also influences the refresh bandwidth of the device. Nowadays high-resolution and color-enriched systems, e.g. a HDTV system having 1920×1080 pixels, are having a significant effect on refresh bandwidth.

As discussed in the above paragraph, a binary weighted PWM driving scheme divides a frame time into a number of time intervals. Each bit of a word represents its own displaying time duration and a new frame of incoming data must be written to storage elements during a single time duration. Generally, LSB of a word has the shortest time duration and data access issue of an entire display device must be completed within this small LSB displaying time interval. When resolution of a display device is boosted to a current television standard, display time duration of LSB is no longer sufficient for the data writing process. As a consequence, high-resolution and color-enriched display devices seek for a modulation scheme or data writing method that can achieve an artifice-free display system.

### SUMMARY OF THE INVENTION

According to the invention there is provided a method of driving a display device, characterised by providing a binary weighted pulse width modulation (PWM), by providing a display device, and by partitioning the display device, whereby to generate write and display sequences of frame data for the display device.

Using the present invention there is thus provided a method to increase frame rate of a display system without increasing its video input data rate. This method overcomes the high-speed data clock constraint of a binary weighted PWM driving system by modulating a bit sequence of PWM and partitioning a display device. In one embodiment, a binary weighted PWM data word is divided into two parts, a Secondary Bit Set (SBS) and a Primary Bit Set (PBS). The SBS data consists of a group of binary weighted data bits. The PBS consists of a group of binary weighted data bits in which each bit of PBS is segmented into N segments of display time interval. Bit sequence of a divided PWM is then modulated, in which bits of SBS are inserted into PBS display time intervals where the inserted bits of SBS are adjacent to a certain PBS display time duration.

In a further embodiment, the modulated PWM data word precedes its writing operation and displaying operation inside a partitioned display device. Display time intervals of bits of SBS in a certain partition is arranged to be located on display time intervals of bits of PBS in another organized partition. For a display device partitioned into two halves, the writing and displaying processes in the first half partition are operating with a modulated bit sequence. Processes running in the second half partition then operate with the same sequence wherein the last two bits are rotated to the front of the modulated bit sequence. In the present invention, using the display device partitioning skill and the bit sequence modulation scheme, data clock rate is reduced by controlling the data writing and displaying operations.

In another embodiment of the present invention, each display unit consists of two storage elements and at least one of the storage elements contains a bit of PBS to be displayed in next frame (frame N+1) period. During a certain segmented display time interval of a bit of PBS, one of the bits of SBS is written into the subsequent storage element of the same display unit. In a further embodiment, with the use of a bit sequence modulation scheme, the data writing process runs incessantly without being influenced by a short display time interval of LSB of a data word.

In a further embodiment of the present invention, a display partitioning skill provides a plurality of partitions in the same device. The modulated PWM data word precedes its writing operation and displaying operation inside a partition of a plurality of partitioned display device. Display time intervals of bits of SBS in a certain partition is arranged to be located on display time intervals of bits of PBS in another organized partition of a plurality partitioned display device.

In yet another embodiment of the present invention, a method of driving a PWM system with display unit having more than two storage elements is provided. At least one of the storage element contains one of the bits of PBS and bits of SBS are written into the two remaining storage elements alternately. A writing and displaying process of the bits of SBS occurs within the same display interval in a single display device without device partitioning.

In a further embodiment, the driving method in the present invention is also applied to a display device, which has been partitioned in a certain number of partitions. In a still further embodiment, each partition of a display device in the present invention is partitioned equally or not equally. Additionally, the number of lines of each partition is not restricted to either a single line or plural lines.

In another embodiment of the present invention, a method of driving a PWM system is extended for displaying an entire frame of data. During a frame period, in which each display unit consists of two storage elements, display duration is fully utilized for writing data words to the display device wherein the writing process occurs only in partition while a bit of PBS is being displayed. In a further embodiment, a display device using the present invention is also used for displaying ongoing frame data.

A method comprising bit set generation, bit set controlling and display device partitioning is established to increase frame rate of a display system, but at its original video input data rate. It is used to achieve artifice-free display system, particularly in high-resolution and color-enriched display devices. Remaining portions of drawings are used for further understanding of the nature and advantages of the invention.

### BRIEF DESCRIPTION OF THE DRAWINGS

FIG. 1A shows schematically a display unit consisting of two storage elements;

FIG. 1B shows schematically a display device, which is driven by a typical binary weighted pulse width modulation scheme;

FIG. 2 shows schematically a binary weighted PWM data word comprising a primary bit set (PBS) and a secondary bit set (SBS);

FIG. 3A shows schematically a binary weighted PWM data word in which all the bits of the PBS are uniformly segmented;

FIG. 3B shows schematically a binary weighted PWM data word in which all the bits of the PBS are non-uniformly segmented;

FIG. 4 shows schematically a modulated bit sequence in which the bits of the SBS are inserted into bits of the segmented PBS;

FIG. 5A shows schematically a display device partitioned in a horizontal direction;

FIG. 5B shows schematically a display device partitioned in a vertical direction;

FIG. 5C shows schematically a display device partitioned in clusters;

FIG. 5D shows schematically a display device partitioned in a diagonal direction;

FIG. 6A shows schematically the writing and displaying operation of a display device in accordance with the present invention;

FIG. 6B shows schematically another writing and displaying operation of a display device in accordance with the present invention;

FIG. 7 shows schematically a modulation scheme in accordance with the present invention in which the display device is partitioned into three partitions;

FIG. 8 shows schematically a modulation scheme in which three storage elements are used for writing and displaying process;

FIG. 9 shows schematically another display device, which is partitioned into a certain number of partitions;

FIG. 10A shows schematically a display device, which is partitioned into 2 partitions, displaying two frames of data words using the present invention; and

FIG. 10B shows schematically a display device, which is partitioned into M partitions, displaying four frames of data words using the present invention.

### DETAIL DESCRIPTION OF THE INVENTION

It is to be understood that the detailed description mentioned below is explanatory only and has no restriction on the present invention.

This present invention makes use of modulated bit sequence and display device partitioning skill to overcome the high-speed data clock constraint of the binary weighted PWM driving system.

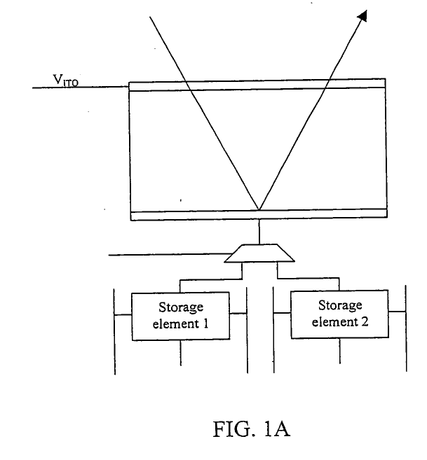

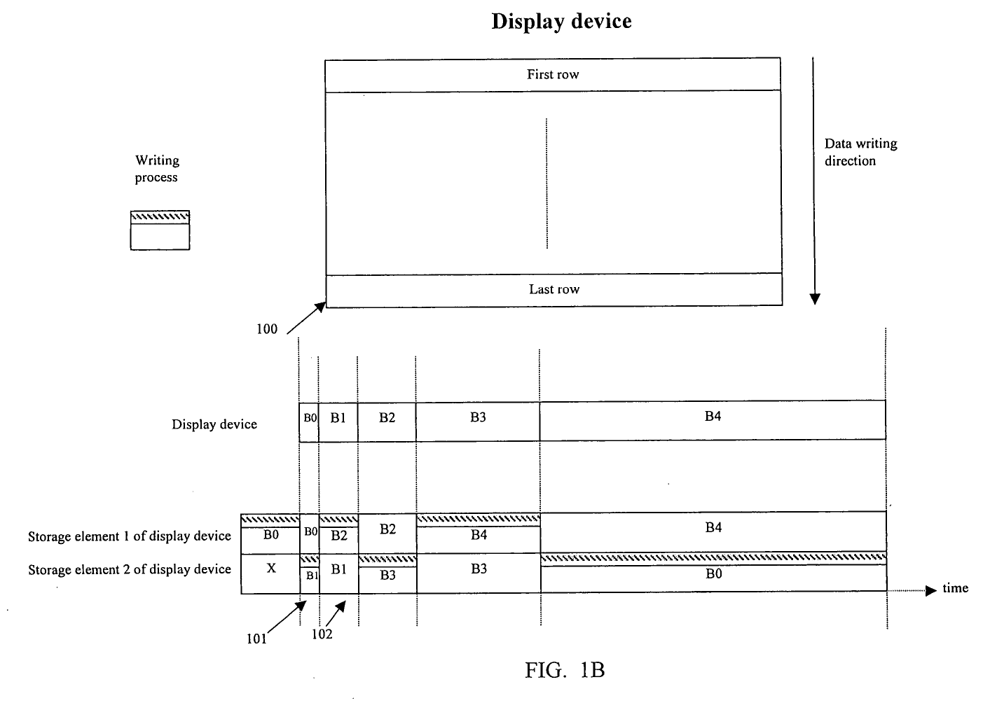

FIG. 1A illustrates a display unit of a device containing 2 storage elements. FIG. 1B shows one embodiment of a display device 100, which is driven by a typical binary weighted pulse width modulation scheme. The writing sequence is from the first row to the last row of the display device. In this example, the write sequence and display sequence of the same bit occur successively. At the display interval 101, the display device is displaying B0 while, at the same time, the B1 of the entire display device is latched into the storage element 2 under the display unit. The writing process of the B1 has to be finished before the end of display time of B0. The writing and displaying process of the next display interval 102 is the same as the one of display interval 101. At the display interval 102, the display device is displaying B1 while, at the same time, the B2 of the entire display is latched into the storage element 1 under the display unit. The writing process of B2 has to be finished before the end of display time of B1. This writing and displaying process described above can be applied to any bits to be displayed on the entire display device.

In this example, the data clock period for writing each bit of the binary weighted PWM signal is equal to:

$$data clock period = frame period \times \frac{bit width}{Max . no . of grayscale level} \times \frac{1}{no . of display unit} \times input bus width$$

where frame period represents the time duration required for displaying one entire frame. For an LCOS imager, in order to apply a DC balancing scheme, the frame period, in this situation, represents the time duration required for displaying either a positive frame or a negative frame. The bit width represents the grayscale level of a particular bit. The max. no. of grayscale level represents the maximum number of the grayscale level that the binary weighted PWM data can be presented. The no. of display unit represents the pixel resolution of the display device i.e. the number of rows times the number of columns. The input bus width represents the number of bits of the input vector.

For example, considering a typical display system having a resolution of 640×480 which is driven by a 5 bits binary weighted PWM data, the data clock period of each bit can be calculated after finalizing the frame period and input bus width. Assuming that the frame period equals to 8.33 ms and the input bus width equals to 8, the data clock periods of each bits are listed below:

| Bit | Data clock | |
|---|---|---|
| number | period | |
| B0 | 6.78 | ns |
| B1 | 13.56 | ns |
| B2 | 27.12 | ns |
| B3 | 54.24 | ns |
| B4 | 108.48 | ns |
| B5 | 216.96 | ns |
| B6 | 433.92 | ns |
| B7 | 867.84 | ns |

The data writing process of this system can be performed in two different embodiments. In one embodiment, each bit of the binary weighted PWM data is driven by different data clock frequency according to the above table. In the other embodiment, all the bits of the binary weighted PWM data is driven by the same data clock frequency and the data clock frequency should be greater than or at least equal to the maximum data clock frequency shown in the above table i.e. the data clock frequency of B0. However, for both embodiments, at least one data clock should be greater than or equal to the maximum data clock frequency shown in the above table i.e. 1/6.78 ns. This high-speed data clock is too expensive to be affordable in most of the systems.

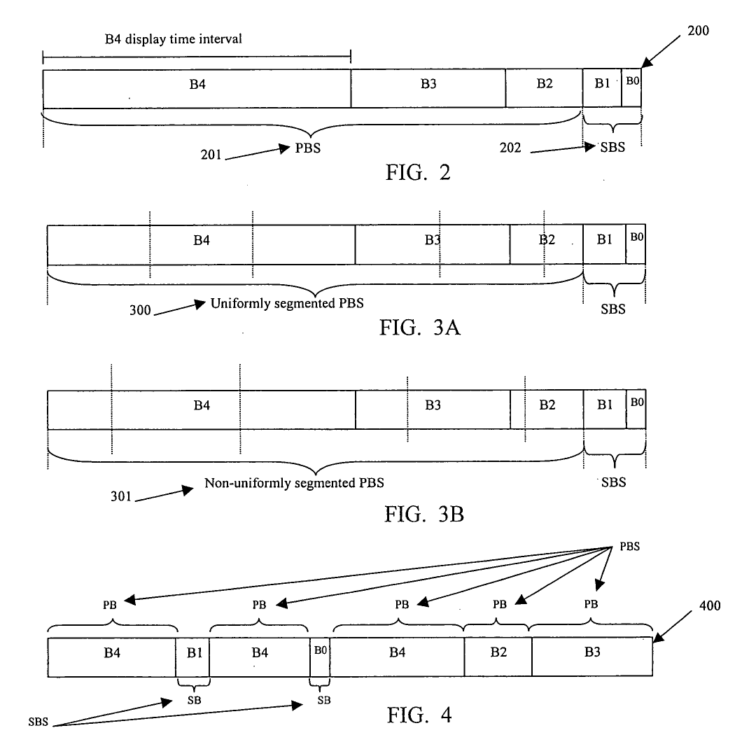

FIG. 2 shows a typical binary weighted PWM data word 200 which is divided into two parts, a primary bit set (PBS) 201 and a secondary bit set (SBS) 202. The secondary bit set (SBS) consists of a group of binary weighted data bits. In the usual case, the SBS comprises a number of less significant bits. But those skilled to the art will recognize that the SBS can comprise any bits within the binary weighted PWM data word. The primary bit set (PBS) consists of a group of binary weighted data bits in which each bit of PBS is segmented into N segments of display time interval.

FIG. 3A shows a typical example in which each bit of the PBS data word 300 is uniformly segmented. The most significant bit B4 is segmented into three portions in which the three portions are equal in length. While B3 and B2 are segmented into two portions in which the two portions are equal in length. FIG. 3B shows another example in which each bit of the PBS data word 301 is non-uniformly segmented. The most significant bit B4 is segmented into three portions in which the three segments are not equal in length. B3 and B2 are segmented into two portions in which the two portions are not equal in length. Those skilled in the art will recognize that the number of segments is not restricted to any number and each bit of the PBS data word can be segmented uniformly or non-uniformly within the same binary weighted PWM data word.

A modulated bit sequence consists of a group of bits of a PBS (also named primary bits PB) and a group of bits of a SBS (also named secondary bits SB), in which the bits of the SBS are inserted into display time intervals of the bits of the PBS where the inserted bits of the SBS are adjacent to the display time interval of the bits of the PBS. FIG. 4 shows an example of a modulated bit sequence 400 in which the two bits B0 and B1 of the SBS are inserted into the bit B4 of the segmented PBS. Those skilled to the art will recognize that it is not required to insert the bits of the SBS into every bit of the PBS.

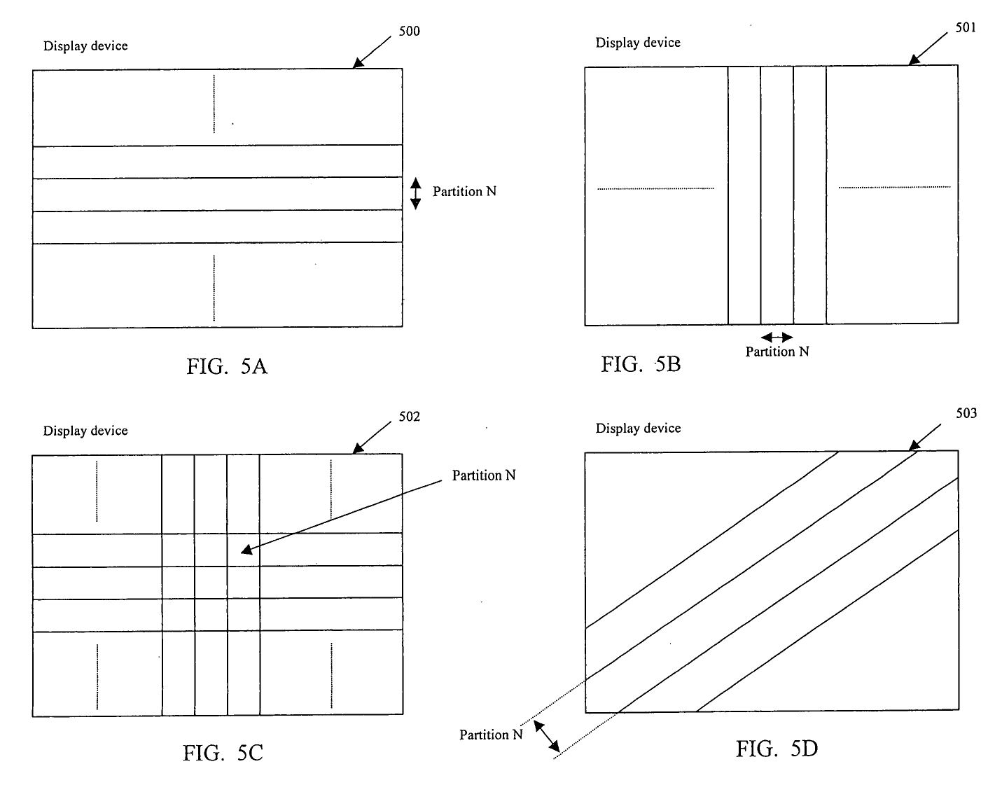

FIG. 5 shows the display device partitioning arrangement that would be used in this invention. The display device is partitioned into N partitions in which for each partition consists of a certain number of rows or columns. FIGS. 5a, b, c and d show different partitioning orientations that can be applied. FIGS. 5a and b show two display devices 500 and 501 being partitioned into N partitions in the horizontal and vertical direction respectively. FIG. 5c shows a display device 502 being partitioned into N clusters while FIG. 5d shows a display device 503 being partitioned into N partitions in diagonal directions. Those skilled to the art will recognize that the partitioning orientations are not limited to the above examples and the width of the two adjacent partitions can be equal or not equal.

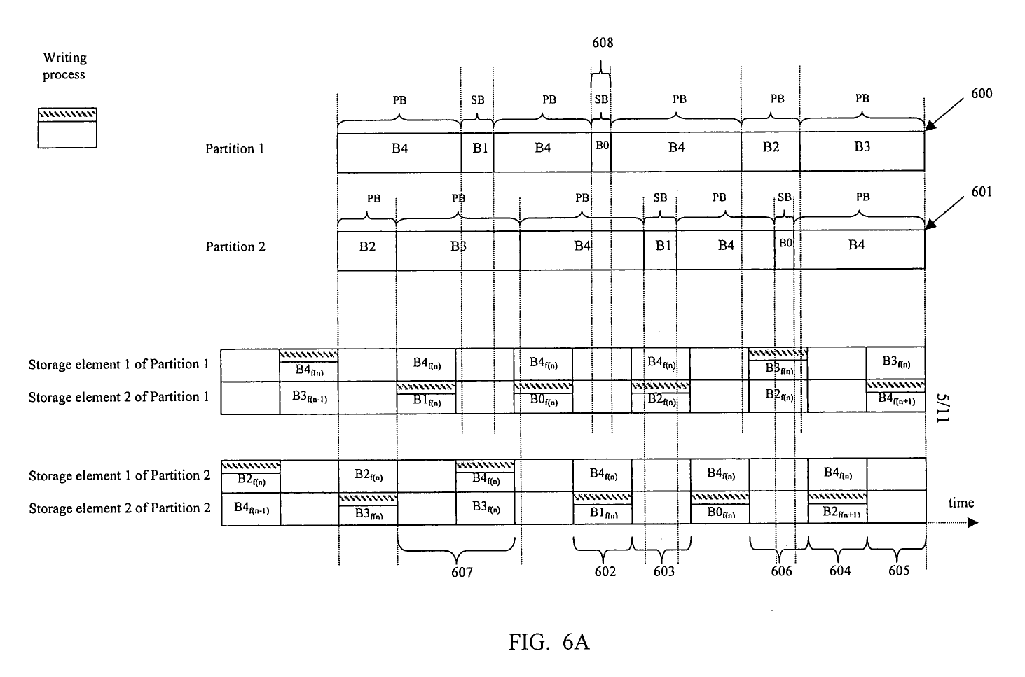

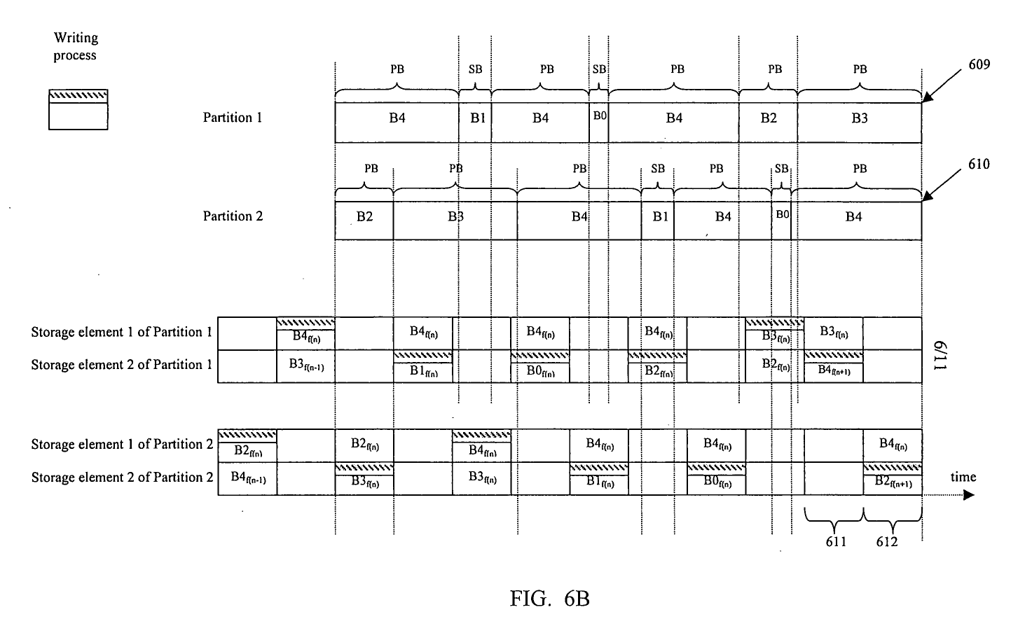

FIG. 6A shows the writing and displaying process of a display device in accordance with the present invention which make use of the display device partitioning arrangement and the modulated bit sequence to reduce the data clock rate. The display device is partitioned into two halves. For the first half partition 600, the liquid crystal is driven by a modulated bit sequence comprising a PBS and a SBS. For the second half partition 601, the liquid crystal is driven by the same modulated bit sequence with the last two bits rotating to the front of the modulated bit sequence. This action makes sure that the display intervals of the bits of the SBS of the first half partition 600 would be located on the display intervals of the bits of the PBS of the second half partition 601 and the display intervals of the bits of the SBS of the second half partition 601 would be located on the display intervals of the bits of the PBS of the first half partition 600. Those skilled to the art will recognize that the invention can be applied to any kind of modulated bit sequences and any number of bits to be rotated.

Each display unit consists of two storage elements and at least one of the storage elements contains a bit of the PBS to be displayed in the next time interval. One of the bits of the SBS would then be written into the remaining storage elements during the display interval of one of the bits of the PBS. At the time interval 602, the storage element 2 of the first half partition 600 contains the bit B0 of the SBS, which is currently being displayed at the first half partition 600 of the display device. At the same time, the other storage element contains the bit B4 of the PBS, which will be displayed after the display interval of the B0 of the SBS. As a result, during the display interval 602, all the storage elements are fully occupied and there is no room for data writing to either one of the two storage elements at the first half partition 600. Without using partitioning skill, the data writing has to be stopped at the time interval 602 as all the storage elements are not available for data writing.

With the bit rotation operation of the modulated bit sequence of the second half partition 601, the display interval of the bit B4 of the PBS of the second half partition 601 is located at the time interval 602. As the bit B3 of the PBS of the second half partition 601 has already been displayed at the time interval 607, the storage element 2 of the second half partition 601 is freed up for new data writing at the time interval 602. By making use of this advantage, the writing process does not need to stop and can continue to write data into the storage element 2 of the second half partition 601.

From the above embodiment, the writing and displaying process of the two partitions can be reversed. At the time interval 603, storage element 2 of the second half partition 601 contains the bit B1 of the SBS, which is currently being displayed at the second half partition 601 of the display device and the other storage element contains the bit B4 of the PBS, which will be displayed after the display interval of the B1 of the SBS. As a result, during the display interval 603, all the storage elements are fully occupied and there is no room for data writing to either one of the two storage elements at the second half partition 601. Without using the partitioning arrangement, the data writing has to be stopped at the time interval 603 as all the storage elements are not available for data writing.

With the bit rotation operation of the modulated bit sequence of the first half partition 600, the display interval of the bit B4 of the PBS of the first half partition 600 is located at the time interval 603. As the bit B0 of the SBS of the first half partition 600 has already been displayed at the time interval 608, the storage element 2 of the first half partition 600 is freed up for new data writing at the time interval 603. By making use of this advantage, the writing process does not need to stop and can continue to write data into the storage element 2 of the first half partition 600.

By fully utilizing the whole frame period for writing data without the constraint that the writing process of a whole page data has to be finished within one bit length, the data clock period for this invention is equal to:

$$data clock period = frame period \times \frac{1}{ no . of bits of PWM data} \times \frac{1}{no . of display unit} \times input bus width$$

Considering a typical display system having resolution of 640×480 and being driven by an 5 bits binary weighted PWM data word with 8 bits input bus width, for the frame period equals to 8.33 ms, the data clock frequency of the system is equal to 1/43 ns. By comparing this result with the data clock period of the system without using this invention, it can be realized that the data clock rate can be greatly reduced without decreasing the frame rate.

At the time interval 604 and 605, both the first and the second half partitions 600 and 601 are displaying the bit B3 and B4 of the PBS respectively. In this situation, as the bit B2 of the first half partition 600 and B0 of the second half partition 601 have already been displayed at the time interval 606, the storage element 2 of both the first and the second half partitions 600 and 601 are freed up and are ready for data writing. As a result, the writing process of the first and the second half partitions during the time interval 604 and 605 can be swappable. In one embodiment shown in FIG. 6A, the writing process of the first half partition 600 occurs at time interval 605 while the writing process of the second half partition 601 occurs at time interval 604. In another embodiment shown in FIG. 6B, the writing process of the first half partition 609 occurs at time interval 611 while the writing process of the second half partition 610 occurs at time interval 612. Both of these two embodiments will not change the bit sequence to be displayed at the display device.

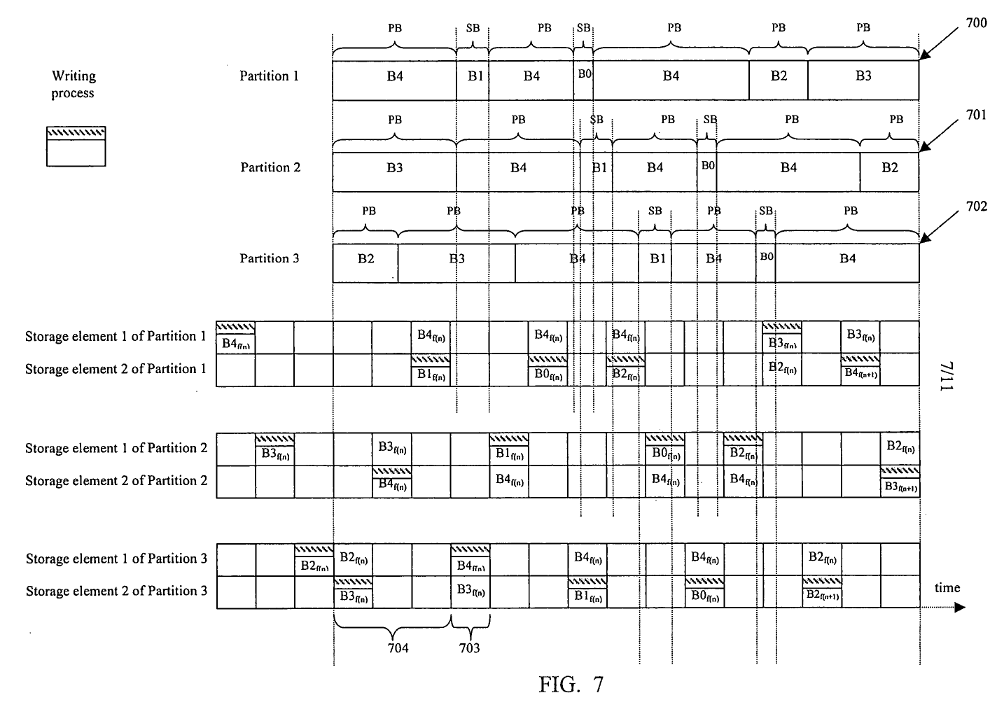

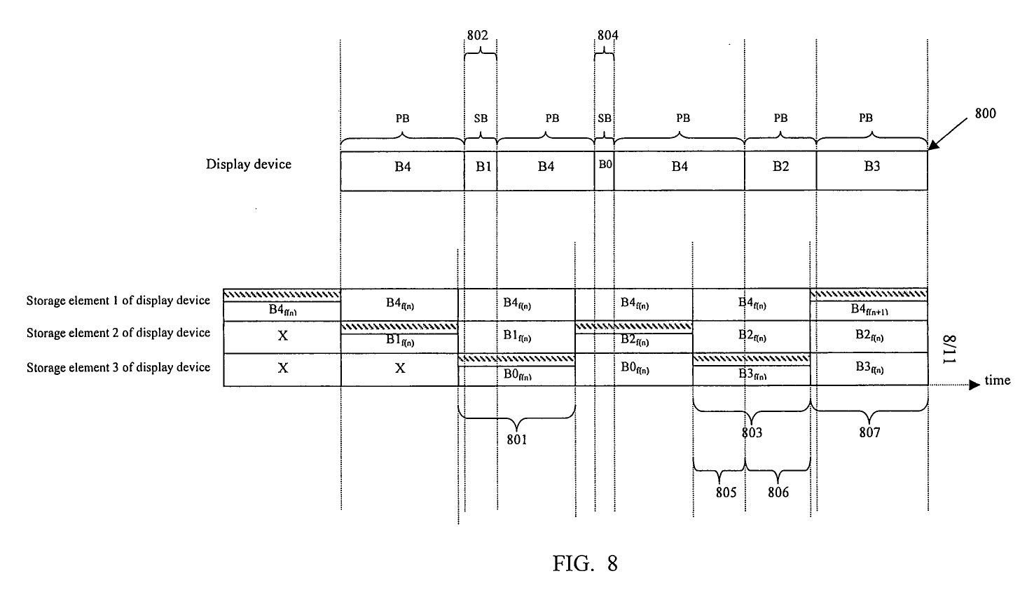

FIG. 7 shows a modulation scheme in accordance with the present invention in which the display device is partitioned into three parts. For the first part partition 700, the liquid crystal is driven by a modulated bit sequence comprising a PBS and a SBS. For the second partition part 701, the liquid crystal is driven by the same modulated bit sequence comprising a PBS and a SBS with the last bit B3 rotating to the front of the modulated bit sequence. For the third partition part 702, the liquid crystal is driven by the same modulated bit sequence, which is shown in the first partition part 700, comprising a PBS and a SBS with the last two bits B2 and B3 rotating to the front of the modulated bit sequence.

This bit rotation operation makes the display intervals of the bits of the SBS of the first partition part 700 to be located on the display intervals of the bits of the PBS of either or both of the second 701 and the third partition part 702. At the same time, the display intervals of the bits of the SBS of the second partition part 701 would be located on the display intervals of the bits of the PBS of either or both of the first 700 and the third partition parts 702. This bits rotation process also makes the display intervals of the bits of the SBS of the third partition part 702 to be located on the display intervals of the bits of the PBS of either or both of the first 700 and the second partition parts 701. Those skilled to the art will recognize that the invention can be applied to any kind of modulated bit sequences and any number of bits to be rotated to the front of the sequence.

Each of the display unit of above embodiment consists of two storage elements and at least one of the storage elements contains a bit of the PBS. The bits of the SBS would then be written into the remaining storage element during the display intervals of the bits of the PBS. At the time interval 703, the storage element 2 of the first partition part 700 contains the bit B1 of the SBS, which is currently displaying at the first partition part 700 of the display device and the other storage element contains the bit B4 of the PBS, which will be displayed after the display interval of the bit B1 of the SBS. As a result, all the storage elements are fully occupied and no room for data writing at the first partition part 700 during the time interval 703.

With the bit rotation operation of the modulated bit sequence of the second 701 and the third partition part 702, the display time of the bits B4 and B3 of the PBS of the second 701 and the third partition part 702 are located at the time interval 703. As the bits B3 and B2 of the PBS of the second part partition 701 and the third partition part 702 have already been displayed at the time interval 704, the storage element 1 of both of the second partition part 701 and the third partition part 702 are free up for new data writing. By making use of this advantage, the writing process does not need to stop and can continue to write data into the storage element 1 of either the second partition part 701 or the third partition part 702.

The above embodiment can be extended to have more than two storage elements under a display unit. FIG. 8 shows a modulation scheme in which three storage elements are used for a writing and displaying process. Those skilled to the art will recognize that the modification can be applied to more than three storage elements.

At the time interval 801, storage element 1 is storing the bit B4 of the PBS while storage element 2 is storing the bit B1 of the SBS, which is currently being displayed at the display device 800 at the time interval 802. The bit B0 of the SBS, which will be displayed at the time interval 804, is written into the additional storage element 3 during the time interval 801. As a result, the writing and displaying process can concurrently occur at the same partition.

In this embodiment, the writing and displaying process of the bits of the PBS is the same as those of the SBS. At the time interval 803, the storage element 1 is storing the bit B4 of the PBS to be displayed at the first portion of the time interval 805 while the storage element 2 is storing the bit B2 of the PBS to be displayed at the last portion of the time interval 806. The bit B3 of the PBS, which will be displayed in time interval 807, is written into the additional storage element 3 during the time interval 803.

Like the driving scheme using two storage elements, this embodiment also requires that at least one of the storage elements contain one of the bits of the PBS and the bits of the SBS inserting into the PBS are written into the two remaining storage elements alternately. As the writing and displaying process of the bits of the SBS can occur within the same display interval, no partitioning of the display device is required. But those skilled to the art should recognize that this embodiment could also be applied to the display device, which has been partitioned in a certain number of partitions.

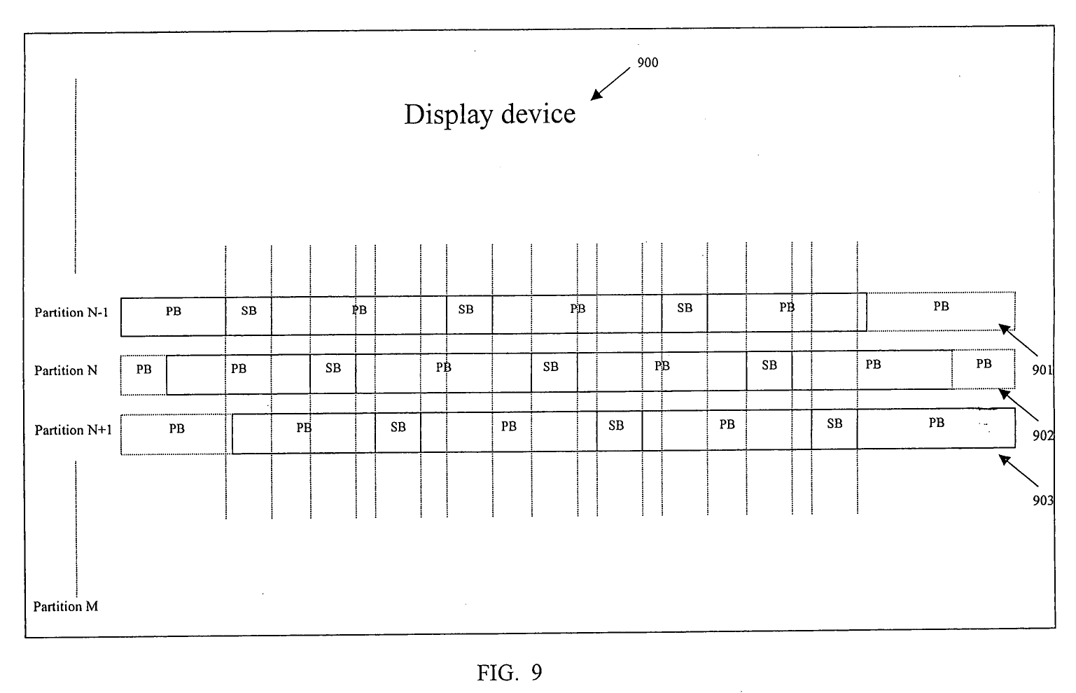

FIG. 9 shows another display device 900 which is partitioned into M partitions. Each partition is loaded with a predefined modulated bit sequence. For partition N−1, the display unit is loaded with a modulated bit sequence 901. For partition N, the display unit is loaded with a modulated bit sequence 902, which is the same as the one in the partition N, having a certain number of bits rotating to the front of the sequence. For partition N+1, the display unit is loaded with a modulated bit sequence 903 further having a certain number of bits rotating to the front of the sequence.

The number of bits to be rotated to the front of the sequence of each modulated bit sequence is guided by the rule that at any display interval, at least one of the partitions is displaying a bit of the PBS. This makes sure that the entire frame period, in which each display unit consists of two storage elements, can be fully utilized for writing data words into the display device as the write process can only occur in the partition displaying PBS. Those skilled to the art will recognize that the width of each partition can be partitioned equally or not equally and the number of lines of each partition is not restricted to either a single line or plural lines.

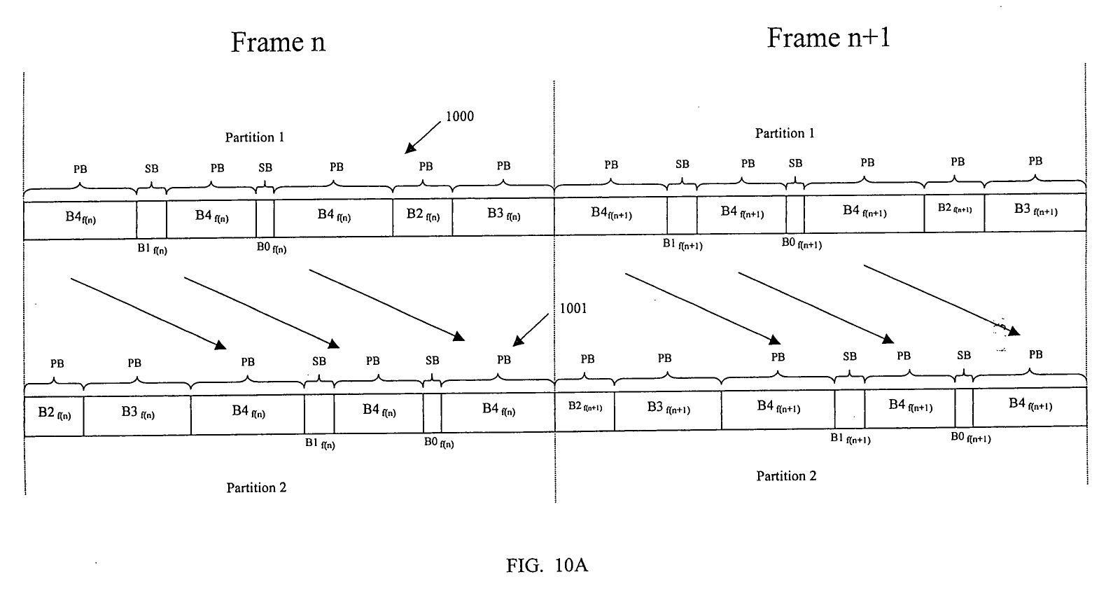

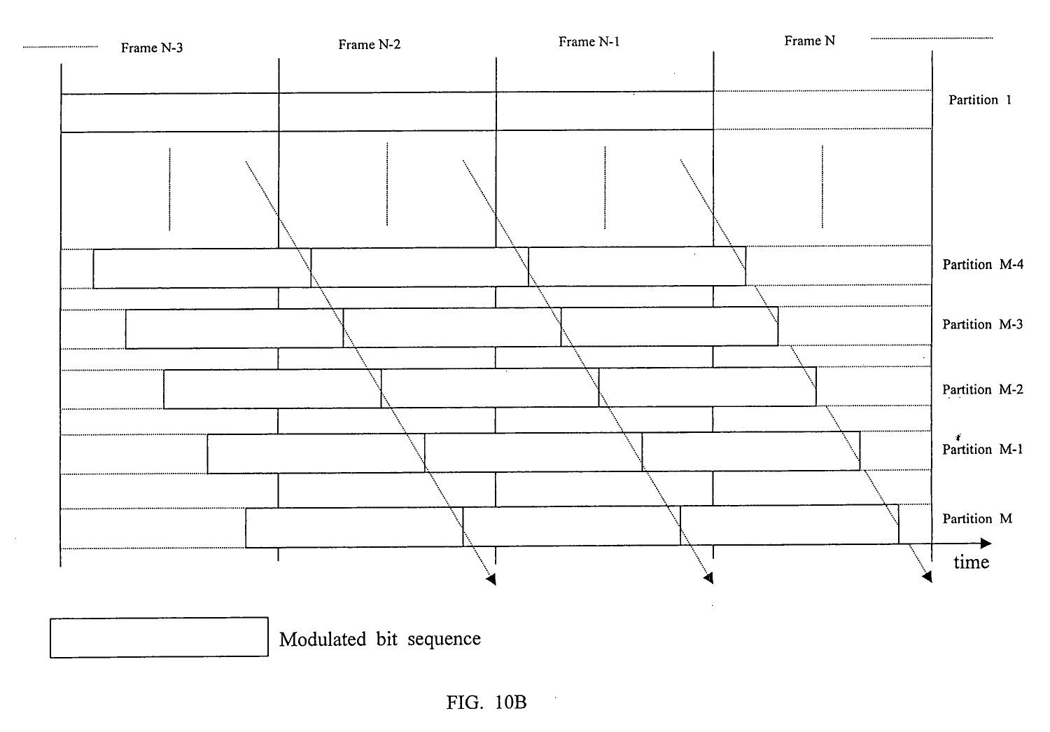

FIG. 10a shows a display device displaying two frames of data words using the present invention. The partition 1 is displaying with a modulated bit sequence 1000 while the partition 2 is displaying with another modulated bit sequence 1001 with two bits B2 and B3 rotating to the front of the bit sequence.

FIG. 10b shows a general case for a display device being partitioned into M partitions. It can be realized that the modulated bit sequences from partition 1 to partition M are being displayed in drafting manner across the partition 1 to partition M.

The above embodiments provide a complete description about the theory and mechanism behind the present invention. Those skilled to the art should recognize that the above embodiments are subjected to any variations without departing from the spirit and scope of the invention.

Using the invention hereinbefore described with reference to the drawings, a new PWM modulation scheme and a new driving method are introduced. With this driving method, the frame rate of a display system is increased without increasing its video input data rate. Or, video input data rate is reduced without changing its frame rate for performing a flicker-free and artifice-free display system.

We claim:

1. A method of driving a display device, comprising:—
(i) providing a binary weighted pulse width modulation;
(ii) providing a display device; and
(iii) partitioning said display device, whereby
(iv) to generate a write sequence and a display sequence of frame data for said display device.

2. A method of driving a display device, having a binary weighted PWM combined with a Primary Bit Set (PBS) and a Secondary Bit Set (SBS), wherein there is:—
(i) a Secondary Bit Set comprising a group of binary weighted data bits;
(ii) a Primary Bit Set comprising a group of binary weighted data bits wherein each bit of PBS is segmented into N segments of display time interval; and
(iii) a bit of SBS is inserted into the PBS display time interval wherein an inserted bit of SBS is adjacent to a PBS display time interval.

3. A method as defined in claim 2, wherein said display time intervals of PBS are uniformly segmented.

4. A method as defined in claim 1, wherein said display time intervals of PBS are non-uniformly segmented.

5. A method as defined in claim 1, wherein said display unit comprises two storage elements and wherein at least one of the storage elements contains a bit of PBS.

6. A method as defined in claim 5, wherein said display device is partitioned for displaying the PBS and SBS.

7. A method as defined in claim 5, wherein said display device comprises a single partition.

8. A method as defined in claim 5, wherein said display device comprises a plurality of partitions.

9. A method as defined in claim 5, wherein said display device is partitioned in a vertical direction.

10. A method as defined in claim 5, wherein said display device is partitioned in a horizontal direction.

11. A method as defined in claim 5, wherein said display device is partitioned in a diagonal direction.

12. A method as defined in claim 5, wherein said display device is partitioned in a total of N partitions and wherein display interval of SBS of an Nth partition is located in a display interval of said PBS of (N−1)th partition.

13. A method as defined in claim 12, wherein for a partition N displaying bits of SBS, no data is written in any storage elements of the storage bank at partition N.

14. A method as defined in claim 12, wherein for a partition N displaying bits of PBS, data is, but not must be, written in any storage elements of the storage bank at partition N.

15. A method as defined in claim 12, wherein at any time of a device displaying operation, at least one partition is displaying bits of PBS.

16. A method as defined in claim 12, wherein the storage bank is modified to contain more than two storage elements.

17. A method as defined in claim 2, wherein said a display unit comprises more than two storage elements wherein at least one of the storage elements contains a bit of PBS.

18. A method as defined in claim 17, wherein for a partition N displaying bits of SBS, data is written in any storage elements of the storage bank at partition N.

19. A method as defined in claim 17, wherein for a partition N displaying bits of PBS, data is written in any storage elements of the storage bank at partition N.

20. A method as defined in claim 11, wherein the width of partition N is a single line.

21. A method as defined in claim 11, wherein the width of partition N is multiple lines.

22. A method as defined in claim 11, wherein the widths of N and (N−1) are equal.

23. A method as defined in claim 11, wherein the widths of N and (N−1) are unequal.

24. A pulse width driving system of a display device, wherein the system is driven by a method as defined in claim 1.

25. A system as defined in claim 24, wherein the display device is a liquid crystal display device.
